(19) United States
(12) Patent Application Publication
(10) Pub. No.: US 2015/0045214 A1
(43) Pub. Date: Feb. 12, 2015

(54) METHOD OF TREATING FUNGAL INFECTIONS, FUNGICIDAL COMPOSITIONS AND THEIR USE

(71) Applicant: ROTAM AGROCHEM INTERNATIONAL CO., LTD, Chia Wan, Hong Kong (CN)

(72) Inventor: James Timothy Bristow, Chai Wan (CN)

(21) Appl. No.: 14/358,099

(22) PCT Filed: Nov. 2, 2012
(86) PCT No.: PCT/CN2012/083986

§ 371 Date: May 14, 2014

(30) Foreign Application Priority Data
Nov. 14, 2011 (GB) 1119534.4

(51) Int. Cl. A01N 25/32; C05G 3/02; A01N 43/653

(52) U.S. Cl. CPC A01N 25/32; A01N 43/653; C05G 3/02
USPC 504/101

(57) ABSTRACT

A fungicidal composition comprising a triazole fungicide and a micronutrient is provided. Further, there is provided a method of improving fungi control and reducing phytotoxicity caused by triazoles, comprising applying a triazole fungicide and micronutrients to the plant or a part thereof, or to surroundings thereof. The triazole fungicide is preferably tebuconazole.

This application is a 371 of PCT/CN2012/083986, filed 2 Nov. 2012, which claims the benefit of Great Britain Patent Application 1119534.4, filed 14 Nov. 2011, the entire contents of each of which are incorporated herein by reference for all purposes.

### TECHNICAL FIELD

The present invention relates to a fungicidal composition, more particularly to a fungicidal composition comprising one or more triazole fungicides and a micronutrient. The present invention further relates to a method of improving fungicidal properties of such compositions and of reducing phytotoxicity caused by triazoles on plants, in particular soybean plants.

### BACKGROUND

Fungal infections represent a major threat to economically important agricultural crops. For example, white mold, caused by the fungus Sclerotinia sclerotiorum, is an important yield limiting disease of soybeans in the north central United States. The fungus is endemic to the north central U.S., and infects almost all dicotyledonous plant species. Because of its wide host range, it is an important pathogen for a wide range of other agricultural crops, including dry beans, sunflowers, canola, potatoes, and all forage legumes.

The protection of crops against fungal infection requires the application of chemicals which protect or combat directly or indirectly the pathogen. These chemicals are called fungicides. Fungicides are generally provided as formulations comprising an active ingredient and, in many cases, one or more adjuvants.

Fungicides may be provided in the form of several different formulations, such as suspension concentrates, suspoemulsions, soluble concentrates, and emulsifiable concentrates.

Triazoles represent a commonly used family of fungicides. They are used on many different types of plants including field crops, fruit trees, small fruit, vegetables, and turf. Triazole fungicides are highly effective against many different fungal diseases, especially powdery mildews, rusts, and many leaf-spotting fungi.

The triazole fungicides are effective in controlling fungal infestations by inhibiting one specific enzyme, C14-demethylase, which plays a role in sterol production. Sterols, such as ergosterol, are needed for membrane structure and function, making them essential for the development of functional cell walls by the fungi. Therefore, these fungicides result in abnormal fungal growth and eventually death.

Though triazoles have been successfully used in fungi control, there have been some concerns that the triazole group of fungicides may cause some leaf burn to plants, especially soybean plants.

There have been some reports of injury on soybean plants associated with triazole applications, especially tebuconazole. Phytotoxicity will occasionally occur when spraying one of the triazole fungicides, such as tebuconazole, during hot and dry conditions and the presence of surfactants in the fungicidal formulation may increase symptoms. Also, there is a varietal difference in the reaction to triazole fungicides, such as tebuconazole; a study at the University of Illinois suggests that approximately 25 percent of cultivars are susceptible to this phytotoxicity. The symptoms of tebuconazole phytotoxicity are very similar to sudden death syndrome (SDS) and brown stem rot (BSR) foliar symptoms (yellowing and browning between the veins). However, symptoms of tebuconazole phytotoxicity will be more uniform across the field than either SDS or BSR, which occur in irregular patches.

Because the site of action of triazoles is very specific, there are also resistance concerns. Indeed, some triazole fungicides have been withdrawn from the marketplace, as resistance to them developed and they no longer provide the desired benefit or advantage in a disease control program.

In order to avoid fungicide resistance, it is recommended to use a full dose, not a reduced dose, of the fungicide. The idea here is that reduced doses give the fungus a chance to adapt to the fungicide because fewer colonies will be completely eliminated, whereas a full dose will kill more colonies, reducing the ability of the fungus to develop a resistance to the active ingredient being employed.

Therefore, there is a continuing need for fungi controlling methods which are improved in terms of efficacy, safety and resistance control.

### SUMMARY OF THE INVENTION

Surprisingly, it has been found that the phytotoxic effects of triazoles, such as tebuconazole, can be significantly reduced if the triazole is present in combination with a micronutrient.

Accordingly, the present invention relates to a fungicidal composition comprising a triazole and a micronutrient which provides improved fungicidal properties and less phytotoxicity. The present invention further relates to a method of using micronutrient to reduce phytotoxicity caused by triazoles on soybean plant.

Accordingly, in a first aspect, the present invention provides a composition comprising a triazole fungicide and a micronutrient.

In another aspect, the present invention provides a method of using a micronutrient to reduce phytotoxicity caused by triazoles on plants, including but not limited to soybean plants.

In a still further aspect, the present invention provides a method of improving fungicidal activity of a fungicide at a locus, the method comprising applying the fungicide and a micronutrient to the locus.

The first aspect of the present invention provides a fungicidal composition comprising a fungicidally active triazole and a micronutrient. The triazole fungicide of the invention may be any fungicidally active triazole compound. Such compounds are known in the art and are commercially available. The fungicidal composition may comprise a single fungicidally active triazole or two or more such triazoles. The triazole active ingredient may be present in combination with one or more other, non-triazole active ingredients, in particular one or more other non-triazole fungicides.

As noted, any fungicidally active triazole may be employed in the present invention. The triazole fungicide is preferably selected from azaconazole, bitertanol, bromuconazole, cyproconazole, diclobutrazole, difenoconazole, diniconazole, enilconazole, epoxiconazole, etaconazole, fenbuconazole, fluquinconazole, flusilazole, flutriafol, hexaconazole, imibenconazole, ipconazole, metconazole, myclobutanil, paclobutrazol, penconazole, propiconazole, prothioconazole, simeconazole, tebuconazole, tetraconazole, triadimefon, triadimenol, triticonazole, and any combination thereof.

Particularly preferred triazoles include tebuconazole, epoxiconazole, difenoconazole, cyproconazole and hexaconazole. Preferably, the triazole fungicide is tebuconazole.

Compositions of the present invention also comprise a micronutrient in combination with the triazole fungicide. As noted, the micronutrient is employed in the present invention to reduce the phytotoxic effects of the triazole active ingredient.

The present invention may employ a single micronutrient or a combination of two or more micronutrient components.

Generally, macronutrients are compositions including nitrogen-, phosphorus-, and potassium-containing compounds. They are consumed in larger quantities by plants and may be present as a whole number or tenths of percentages in plant tissues (on a dry matter weight basis). Micronutrients are trace elements, typically absorbed by a plant from the air, water and/or soil, and required by the plant in small quantities, with concentrations in the plant ranging from 5 to 100 parts per million (ppm) by mass of the plant. Micronutrients are essential to plant growth and health. If a plant lacks a micronutrient it requires, the growth of the plant and/or quality and quantity of the crop may be adversely affected. This may result in large economic losses.

The micronutrients employed in the present invention include salts of metal cations, for example salts of metals of Group I, Group II or transition metals, in particular salts of cations of Na, K, Fe, Mn, Zn, Cu and Mo, with anions of inorganic or organic acids. Ammonium salts may also be used. Examples of suitable inorganic acids are hydrohalic acids, such as hydrochloric acid and hydrobromic acid, carbonic acid, sulphuric acid, phosphoric acid and nitric acid. Suitable organic acids are, for example, formic acid and alkanoic acids, such as acetic acid, trifluoroacetic acid trichloroacetic acid and propionic acid, and also glycolic acid, glucoheptonic acid, thiocyanic acid, lactic acid, succinic acid, citric acid, benzoic acid, cinnamic acid, oxalic acid, alkylsulfonic acids (sulfonic acids having straight-chain or branched alkyl radicals of 1 to 20 carbon atoms), arylsulfonic acids or disulfonic acids (aromatic radicals, such as phenyl and naphthyl, which carry one or two sulfonic acid groups), alkylphosphonic acids (phosphonic acids having straight-chain or branched alkyl radicals of 1 to 20 carbon atoms), arylphosphonic acids or diphosphonic acids (aromatic radicals, such as phenyl and naphthyl, which carry one or two phosphoric acid radicals), where the alkyl or aryl radicals may carry further substituents, for example p-toluenesulfonic acid, salicylic acid, p-aminosalicylic acid, 2-phenoxybenzoic acid, and 2-acetoxybenzoic acid.

Preferred salts for use as the micronutrient are sulphates, molybdates, phosphates, hydrogenphosphites, nitrates, halides, in particular chlorides, borates, carbonates and vitriols.

The micronutrient employed in the present invention may comprise boron (B) in the form of metal salts of H₂BO³⁻ and HBO₃²⁻, boric acid and salts of tetraborate and polyborate.

Preferred compounds for use as micronutrients are metals salts of cations of Fe, Mn, Zn, Cu and Mo with anions such as chloride, bromide, sulfate, carbonate, hydrogencarbonate, phosphate, phosphate, hydrogenphosphate, hydrogenphosphite, formate, acetate and glucoheptonate, sodium borate, calcium borate, sodium tetraborate (borax), disodium octoborate tetrahydrate, sodium polyborate and boric acid.

In the present invention, all the micronutrients described above can be applied alone or in any combination with others.

The triazole fungicide may be present in the composition in any suitable amount, and is generally present in an amount of from 0.5% to 80% by weight of the composition, preferably from 1% to 60% by weight of the composition, more preferably from 2% to 50% by weight of the composition.

The one or more micronutrients may be present in the composition in any suitable amount, and is generally present in an amount of from 0.5% to 50% by weight of the composition, preferably from 1% to 40% by weight of the composition, more preferably from 2% to 20% by weight of the composition.

As noted, a further aspect of the present invention provides a method of using a micronutrient to reduce phytotoxicity caused by triazoles on plants. The method is applicable to a wide range of plants that are susceptible to phytotoxic effects of having a triazole fungicide applied thereto. Such plants include, but are not limited to, soybean plants. The triazole and the micronutrient may be applied together, for example by means of a single composition as described hereinbefore. Alternatively, the triazole and the micronutrient may be applied separately to the target plants, for example simultaneously by means of different compositions or consecutively. It is convenient that the triazole and the micronutrient are applied in combination by means of the same composition.

As further noted above, the present invention also provides a method of improving fungicidal activity of a fungicide at a locus, the method comprising applying a fungicide and a micronutrient to the locus. As discussed in more detail below, it has been found that the presence of a micronutrient can enhance the fungicidal activity of triazole fungicides. In the method, the triazole active ingredient is applied to a locus with the micronutrient. The triazole and the micronutrient may be applied separately to the locus, either simultaneously or consecutively, in which case, the sequence of application of the triazole and micronutrients generally has no effect on the fungicidal property and phytotoxicity of the composition. More preferably, the triazole and the micronutrient are present in the same composition and applied together to the locus.

The triazole fungicide and the micronutrients may be present in the composition or applied to a locus in any ratio relative to each other. In particular, the weight ratio of the two components in the composition independently or as applied to a locus is preferably in the range of from 100:1 to 1:100, more preferably from 1:50 to 50:1, still more preferably from 1:20 to 20:1.

### DETAILED DESCRIPTION OF THE INVENTION

Tebuconazole, together with other triazoles, is notable among most other foliar fungicides in that it is toxic to plants (phytotoxic) at rates normally required to provide adequate control against fungal diseases. Tebuconazole phytotoxicity has been recorded at higher use rates in many crop species including soybeans, cocoa, winter grass and rock melons. In most of these cases, symptoms have included obvious death of leaf tissue.

The phytotoxic effects of tebuconazole appear to be exacerbated when applied to plants under drought stress. High temperatures and addition of crop oils to fungicide tank mixes are also thought to increase plant susceptibility to phytotoxicity. Phototoxic effects have also been shown to be variety dependent in some species, for example Poa annua (winter grass) and soybean. The ambient or prevailing temperature at the plant site can also play a role in the level of phytotoxic effects displayed by the plants. For example, phytotoxicity caused by the application of tebuconazole is observed on some Brazilian soybean varieties at temperatures >86 F.

In summary, the existing EC and SC formulations of tebuconazole may cause serious injuries to crops. The EC formulation cause phytotoxicity on soybean crops and the SC formulations cause crop injury in some varieties.

It has been surprisingly found by the inventor that micronutrients can act as a “safener”, that is to minimize the adverse crop response to triazole fungicides, especially tebuconazole. Accordingly, the present invention significantly reduces the side effects or crop injury caused by the application of triazole fungicides. In other words, the micronutrients increase the tolerance of crops to triazole fungicides. Notably, the present invention enables triazole fungicides, for example tebuconazole, to be applied to all varieties of vulnerable plants, such as soybeans, especially those varieties suffering severe injury when triazole fungicides are applied alone.

It was also surprisingly found that the application of a triazole fungicide and a micronutrient in a combined treatment of plants exhibits a significantly improved fungi control, in particular a fungus named Sclerotinia sclerotiorum. In other words, the sensitivity of the fungus to the fungicide is increased by the presence of micronutrients. This in turn reduces the possibility of the occurrence of resistant fungi.

Further, this increased sensitivity of fungal infections to the triazole active ingredients, in combination with the increased tolerance of the crop, offers a much greater degree of flexibility in determining the dosage of the active ingredient applied. A user may more freely choose the dosage, taking into consideration both the efficacy and the side effect.

The triazole fungicide of the invention may be any fungicidally active triazole compound. Such compounds are known in the art and are commercially available. A single triazole active ingredient may be employed. Alternatively, two or more triazole compounds may be used. The triazole active ingredient may also be used in combination with other agrochemically active ingredients.

The triazole fungicide is preferably selected from azaconazole, bitertanol, bromuconazole, cyproconazole, diclobutrazole, difenoconazole, diniconazole, enilconazole, epoxiconazole, etaconazole, fenbuconazole, fluquinconazole, flusilazole, flutriafol, hexaconazole, imibenconazole, ipconazole, metconazole, myclobutanil, paclobutrazol, penconazole, propiconazole, prothioconazole, simeconazole, tebuconazole, tetraconazole, triadimefon, triadimenol, triticonazole, and any combination thereof.

Particularly preferred triazoles include tebuconazole, epoxiconazole, difenoconazole, cyproconazole and hexaconazole. Preferably, the triazole fungicide is tebuconazole.

Suitable micronutrient components for use in the present invention are known in the art and are commercially available. The micronutrients of use in the invention include salts of metal cations, including salts of Na, K, Fe, Mn, Zn, Cu and Mo, with anions of inorganic or organic acids. Ammonium salts may also be used. Examples of inorganic acids are hydrohalic acids, carbonic acid, sulphuric acid, phosphoric acid and nitric acid. Suitable organic acids are, for example, formic acid and alkanoic acids, such as acetic acid, trifluoroacetic acid trichloroacetic acid and propionic acid, and also glycolic acid, glucoheptonic acid, thiocyanic acid, lactic acid, succinic acid, citric acid, benzoic acid, cinnamic acid, oxalic acid, alkylsulfonic acids (sulfonic acids having straight-chain or branched alkyl radicals of 1 to 20 carbon atoms), arylsulfonic acids or disulfonic acids (aromatic radicals, such as phenyl and naphthyl, which carry one or two sulfonic acid groups), alkylphosphonic acids (phosphonic acids having straight-chain or branched alkyl radicals of 1 to 20 car-bon atoms), arylphosphonic acids or diphosphonic acids (aromatic radicals, such as phenyl and naphthyl, which carry one or two phosphoric acid radicals), where the alkyl or aryl radicals may carry further substituents, for example p-toluenesulfonic acid, salicylic acid, p-aminosalicylic acid, 2-phenoxybenzoic acid, and 2-acetoxybenzoic acid.

Preferred salts for use as the micronutrient are sulphates, molybdates, phosphates, hydrogenphosphites, nitrates, halides, in particular chlorides, borates, carbonates and vitriols.

The micronutrients of the invention may further include boron (B) in the form of metal salts of H₂BO³⁻ and HBO₃²⁻, boric acid and salts of tetraborate and polyborate.

Preferred are metals salts of cations of Na, K, Fe, Mn, Zn, Cu and Mo with anions such as chloride, bromide, sulfate, carbonate, hydrogencarbonate, phosphate, phosphate, hydrogenphosphate, hydrogenphosphite, formate, acetate and glucoheptonate.

If boron is present in the micronutrient component, it is preferably present as sodium borate, calcium borate, sodium tetraborate (borax), disodium octoborate tetrahydrate, sodium polyborate and boric acid.

The invention may employ a single micronutrient component or two or more micronutrients in combination. If a boron-containing compound is provided as the micronutrient, it is preferably provided in combination with one or more of the other micronutrient compounds indicated above.

The triazole fungicide and micronutrient may be applied in a single formulation, or in separate formulations. In the latter case, the triazole fungicide and the micronutrients may be applied sequentially, separately or simultaneously.

As noted above, the present invention provides in one aspect a composition for treating fungicidal infestations of plants, the composition comprising a fungicidally active triazole and a micronutrient. The triazole fungicide may be present in the composition in any suitable amount, and is generally present in an amount of from 0.5% to 80% by weight of the composition, preferably from 1% to 60% by weight of the composition, more preferably from 2% to 50% by weight of the composition.

The micronutrient may be present in the composition in any suitable amount, and is generally present in an amount of from 0.5% to 50% by weight of the composition, preferably from 1% to 40% by weight of the composition, more preferably from 2% to 20% by weight of the composition.

The triazole fungicide and the micronutrient may be present in the composition or applied in any suitable ratio relative to each other. In particular, the weight ratio of the two components in the composition independently is preferably in the range of from 100:1 to 1:100, preferably 1:20 to 20:1.

The composition of the invention may contain optionally one or more auxiliaries. The auxiliaries employed in the composition will depend upon the type of formulation and/or the manner in which the formulation is to be applied by the end user. Suitable auxiliaries are all customary formulation adjuvant or components, such as organic solvents, stabilizer, anti-foams, emulsifiers, antifreeze agents, preservatives, antioxidants, colorants, thickeners and inert fillers. Such auxiliaries are known in the art and are commercially available.

The composition may contain optionally one or more surfactants which are preferably non-ionic, cationic and/or anionic in nature and surfactant mixtures which have good emulsifying, dispersing and wetting properties, depending on the nature of the active ingredient to be formulated. Suitable surfactants are known in the art and are commercially available. Suitable anionic surfactants include the so-called water-soluble soaps or water-soluble synthetic surface-active compounds. Soaps which may be used include the alkali metal, alkaline earth metal or substituted or unsubstituted ammonium salts of higher fatty acid (C₁₀-C₂₂), for example the sodium or potassium salt of oleic or stearic acid, or of natural fatty acid mixtures. The surfactant may be an emulsifier, dispersant or wetting agent of ionic or nonionic type. Examples of such surfactants which may be used are salts of polyacrylic acids, salts of lignosulphonic acid, salts of phenylsulphonic or naphthalenesulphonic acids, polycondensates of ethylene oxide with fatty alcohols or with fatty acids or with fatty amines, substituted phenols, especially alkylphenols, sulphosuccinic ester salts, taurine derivatives, especially alkyltaurates, or phosphoric esters of polyethoxylated phenols or alcohols. The presence of at least one surfactant is generally required when the active ingredient and/or the inert carrier and/or auxiliary/adjuvant are insoluble in water and the vehicle for the final application of the composition is water.

The fungicidal composition optionally further comprises one or more polymeric stabilizer. The suitable polymeric stabilizers that may be used in the present invention include, but are not limited to, polypropylene, polyisobutylene, polyisoprene, copolymers of monoolefins and diolefins, polyacrylates, polystyrene, polyvinyl acetate, polyurethanes or polyamides. Suitable stabilizers are known in the art and are commercially available.

The surfactants and polymeric stabilizers mentioned above are generally believed to impart stability to the composition, in turn allowing the composition to be formulated, stored, transported and applied.

The composition may include an anti-foam agent. Suitable anti-foam agents include all substances which can normally be used for this purpose in agrochemical compositions. Suitable anti-foam agents are known in the art and are available commercially. Particularly preferred antifoam agents are mixtures of polydimethylsiloxanes and perfluroalkylphosphonic acids, such as the silicone anti-foam agents available from GE or Compton.

The composition may comprise one or more solvents. The solvent may be organic or inorganic. Suitable organic solvents are selected from all customary organic solvents which thoroughly dissolve the agrochemically active substances employed. Again, suitable organic solvents for the triazole active ingredients are known in the art. The following may be mentioned as being preferred: N-methyl pyrrolidone, N-octyl pyrrolidone, cyclohexyl-1-pyrrolidone; or Solvesso 200, a mixture of paraffinic, isoparaffinic, cycloparaffinic and aromatic hydrocarbons. Suitable solvents are commercially available.

One or more preservatives may also be present in the composition. Suitable preservatives include all substances which can normally be used for this purpose in agrochemical compositions of this type and again are well known in the art. Suitable examples that may be mentioned include Preventol® (from Bayer AG) and Proxel® (from Bayer AG).

Further, the composition may include one or more antioxidants. Suitable antioxidants are all substances which can normally be used for this purpose in agrochemical compositions, as is known in the art. Preference is given to butylated hydroxytoluene.

Liquid compositions may further comprise one or more thickeners. Suitable thickeners include all substances which can normally be used for this purpose in agrochemical compositions. For example xanthan gum, PVOH, cellulose and its derivatives, clay hydrated silicates, magnesium aluminum silicates or a mixture thereof. Again, such thickeners are known in the art and available commercially.

Each of the compositions of the present invention can be used in the agricultural sector and related fields of use for controlling or preventing disease, infestation and/or pest damage on plants.

Each of the compositions according to the present invention is effective against phytopathogenic fungi, in particular occurring in plants, especially in soybean plants. Such pathogenic infestations include Soybean rust (Phakopsora pachyrhizi); Anthracnose (Colletotrichum truncatum); Powdery mildew (Erysiphe diffusa); Soybean powdery mildew (Microsphaera diffusa); Soybean Brown Spot (Septoria glycines); End Cycle disease-leaf blight (Cercospora kikuchii); Downy mildew (Peronospora manshurica); White mold (Sclerotinia sclerotiorum).

The compositions of the present invention are particularly effective against the fungus Sclerotinia sclerotiorum, which is the fungal pathogen causing white mold.

The composition and methods according to the present invention is suitable for a wide range of plants. The composition and the methods of the present invention may be applied in particular to the following crops: cereals (wheat, barley, rye, oats, corn, rice, sorghum, triticale and related crops); beet (sugar beet and fodder beet); leguminous plants (beans, lentils, peas, soybeans); oil plants (rape, mustard, sunflowers); cucumber plants (marrows, cucumbers, melons); fibre plants (cotton, flax, hemp, jute); vegetables (spinach, lettuce, asparagus, cabbages, carrots, onions, tomatoes, potatoes, paprika); as well as ornamentals (flowers, shrubs, broad-leaved trees and evergreens, such as conifers). Especially suitable target plants are wheat, barley, rye, oats, triticale, corn, and soybean. The composition and methods of the present invention have been found to be particularly effective in the treatment of fungal infestations of soybean.

The composition of the present invention may contain or be mixed with other pesticides, such as other fungicides, insecticides and nematicides. The composition of the present invention may contain or be mixed with other fertilizers, such as nitrogen-containing fertilizer, phosphorous-containing fertilizer.

The rates of application (use) of the composition of the present invention vary, for example, according to types of uses, types of crops, the specific active ingredients in the combination, types of plants, but is such that the active ingredients in the combination is an effective amount to provide the desired action (such as disease or pest control). The application rate of the composition for a given set of conditions can readily be determined by trials.

Generally for soybean treatment, application rates for the composition of the present invention can vary from 5 g to 2000 g per hectare (g/ha) of the composition. The application rate will depend upon the particular formulation of the composition, the concentrations of the triazole and micronutrients present in the composition, and the intended purpose. The appropriate application rate can be readily determined by a skilled person in this field.

Application rates for the triazole active ingredient are generally from 1 to 1000 g/ha, more preferably from 10 to 500 g/ha. Application rates for the micronutrient are generally from 1 to 10000 g/ha, more preferably from 10 to 5000 g/ha. Again, the particular application rate of the triazole and micronutrient employed can be readily determined by a person skilled in the art.

The triazole fungicide and the micronutrients, and any other pesticides, may be applied and used in pure form, as a solid active ingredient, for example, in a specific particle size, or, more preferably as a formulation, together with at least one of the auxiliary or adjuvant components, as is customary in formulation technology, such as extenders, for example solvents or solid carriers, or surface-active compounds (surfactants), as described in more detail above. The presence of suitable auxiliary or adjuvant ensures a fine and even distribution of triazole fungicide and the micronutrient after dilution. Preferably, the composition of the present invention is an emulsion, an emulsion concentrate, a water-soluble concentrate, a suspension concentrate, a suspoemulsion, water-dispersible granules, water-soluble granules, water-dispersible powders, water-soluble powders, microcapsule granules, microcapsule suspensions. The formulation type depends on the triazole and micronutrients properties.

Where the triazole active ingredient and the micronutrient are applied to a locus separately, the triazole fungicide may be applied as any of the customary formulations, for example solutions, emulsions, suspensions, powders, pastes and granules. The micronutrients can be applied as solutions, granules, suspensions, powders, or microcapsules. Preparations of these formulations are known in the art. Commercially available triazole fungicide formulations and micronutrient compositions are preferred in this case.

The composition of the invention may be applied to the plant of interest, to a part thereof (such as the leaf or seed), or to surroundings thereof. Methods and techniques for applying the different types of compositions are known in the art.

In another aspect, the present invention provides a method of protecting a plant against a fungus, comprising applying a triazole fungicide and one or more micronutrients to the plant or a part thereof, or to surroundings thereof.

The triazole fungicide and the micronutrients may be applied in any suitable form, as described above. The triazole fungicide and the micronutrients can be applied to the locus where control is desired either simultaneously or in succession at short intervals, for example on the same day. In a preferred embodiment, the triazole fungicide and the micronutrients are applied simultaneously, in particular by way of a composition of the present invention.

The triazole fungicide and the micronutrient may be applied to the plant or locus in any order. Each component may be applied just once or a plurality of times. Preferably, each of the components is applied a plurality of times, in particular from 2 to 5 times, more preferably 3 times.

The triazole fungicide and the micronutrient may be applied in any amounts relative to each other. In particular, the relative amounts of the components to be applied to the plant or locus are as hereinbefore described, with the weight ratio of triazole fungicide to the micronutrient preferably being in the range of from 1:100 to 100:1, more preferably from 1:50 to 50:1.

In the event the triazole fungicide and the micronutrients are applied simultaneously, they can be obtained from a separate formulation source and mixed together (known as a tank-mix, ready-to-apply, spray broth, or slurry), optionally with other pesticides, or they can be obtained as a single formulation mixture source (known as a pre-mix, concentrate, formulated compound (or product)), and optionally mixed together with other pesticides.

In one embodiment of the present invention, the combination of the triazole fungicide and micronutrients are applied as a composition, as hereinbefore described.

Examples of formulation types for pre-mix compositions of a triazole and a micronutrient and their preparation are as follows:

A) Water-Soluble Concentrate (SL)

A triazole and one or more micronutrients according to the invention are dissolved in a water-soluble solvent. As an alternative, wetting agents or other auxiliaries are added. The active compound dissolves upon dilution with water.

B) Emulsifiable Concentrates (EC)

A triazole and one or more micronutrients according to the invention are dissolved in one or more solvents with the addition of one or more non-anionic emulsifiers and anionic emulsifiers and stirred to get a uniform formulation. Dilution with water gives an emulsion.

C) Emulsions (EW)

A triazole and one or more micronutrients according to the invention are dissolved in one or more suitable solvents with the addition of one or more non-anionic emulsifiers and anionic emulsifiers. This mixture is introduced into water by means of an emulsifying machine and made into a homogeneous emulsion. Dilution with water gives an emulsion.

D) Suspension (SC, OD, FS)

In an agitated ball mill, a triazole and one or more micronutrients according to the invention are comminuted with the addition of dispersants and one or more wetting agents and water or other solvent to give a fine active compound suspension. Dilution with water gives a stable suspension of the active compound.

E) Water-Dispersible Granules and Water-Soluble Granules (WG, SG)

A triazole and one or more micronutrients according to the invention are ground finely with the addition of one or more dispersants and one or more wetting agents and prepared as water-dispersible or water-soluble granules by means of technical appliances (for example extrusion, spray tower, fluidized bed). Dilution with water gives a stable dispersion or solution of the active compound.

F) Water-Dispersible Powders and Water-Soluble Powders (WP,SP)

A triazole and one or more micronutrients according to the invention are ground in a rotor-stator mill with the addition of a suitable amount (such as 25 parts by weight) of dispersants, wetting agents and silica gel. Dilution with water gives a stable dispersion or solution of the active compound.

Using such formulations, either straight (that is undiluted) or diluted with a suitable solvent, especially water, plants and loci can be treated and protected against damage, for example by pathogen(s), by spraying, pouring or immersing.

Each and/or any technical feature of one embodiment of the present invention may be freely and independently combined with any other embodiment of the present invention. That is, one or more of the technical features of any embodiment of the present invention may be recombined with any other technical feature.

The following examples are given by way of illustration and not by way of limitation of the invention.

The formulations of the examples were prepared in a manner known in the art following the general procedures outlined above.

### EXAMPLES

### Example 1

### Water-Soluble Concentrates (SL)

A water soluble concentrate comprising tebuconazole and a micronutrient component was formed having the composition as set out in the following table:

| | | |
|---|---|---|
| Tebuconazole | 25 | g |
| Micronutrient | 5 | g |
| TWEEN 80 (Sorbitan monooleate ethoxylate) | 10 | g |
| N-methyl pyrrolidone | balance to 100 | g |

The micronutrient was composed of 50% ferrous sulfate, 30% zinc sulfate and 20% manganese sulfate.

### Example 2

### Emulsifiable Concentrates (EC)

An emulsifiable concentrate comprising tebuconazole and a micronutrient component was prepared having the composition set out in the following table:

| | | |
|---|---|---|
| Tebuconazole | 50 | g |
| Micronutrient | 2.5 | g |
| TWEEN 80 (Sorbitan monooleate ethoxylate) | 10 | g |
| Calcium dodecylphenylsulfonate (70B) | 4 | g |
| Solvesso 200 | 10 | g |
| N-methyl pyrrolidone | balance to 100 | g |

The micronutrient was composed of 40% ferrous sulfate, 20% zinc sulfate, 20% manganese sulfate, 10% copper sulfate, 4% ammonium molybdate and 6% sodium tetraphosphate.

### Example 3

### Water-Dispersible Powders (WP)

A water dispersible powder comprising hexaconazole and a micronutrient component was prepared having the composition set out in the following table:

| | | |
|---|---|---|
| Hexaconazole | 80 | g |
| Micronutrient | 0.8 | g |
| Dispersogen1494 (sodium salt of a | 5 | g |
| cresol-formaldehyde condensation) | | |
| Kaolin | balance to 100 | g |

The micronutrient was composed of 20% boric acid, 10% potassium nitrate, 10% ammonium chloride, 50% potassium dihydrogen phosphate and 10% potassium chloride.

### Example 4

### Water-Dispersible Granules (WG)

Water dispersible granules comprising cyproconazole as the fungicidally active ingredient and a micronutrient component were prepared having the composition set out in the following table:

| | | |
|---|---|---|
| Cyproconazole | 60 | g |
| Micronutrient | 3 | g |
| Poly vinyl alcohol | 2 | g |
| Dispersogen1494 (sodium salt of a | 5 | g |
| cresol-formaldehyde condensation) | | |
| Kaolin | balance to 100 | g |

The micronutrient was composed of 50% sodium borate, 10% potassium sulfate, 10% ammonium chloride, 20% sodium tetraborate and 10% potassium chloride.

### Example 5

### Suspension

A suspension formulation comprising difenoconazole as the fungicidally active ingredient in combination with a micronutrient component was prepared. The composition of the suspension formulation is summarized in the following table:

| | | |
|---|---|---|
| Difenoconazole | 2 | g |
| Micronutrient | 2 | g |
| Dispersogen 4387 (anionic polymeric ester) | 5 | g |
| Propylene glycol | 5 | g |
| Xanthan Gum | 2 | g |
| Water | balance to 100 | g |

The micronutrient was composed of 50% sodium borate, 10% copper sulfate, 10% iron vitriol, 20% sodium tetraborate and 10% potassium chloride.

### Example 6

### Water-Soluble Concentrates (SL)

A water soluble concentrate formulation was prepared comprising tebuconazole and a micronutrient component. The composition of the concentrate formulation is summarized in the following table:

| | | |
|---|---|---|
| Tebuconazole | 0.5 | g |
| Micronutrient | 50 | g |
| TWEEN 80 (Sorbitan monooleate ethoxylate) | 10 | g |
| N-methyl pyrrolidone | 5 | g |
| Water | balance to 100 | g |

The micronutrient was composed of 40% calcium borate, 20% sodium tetraborate, 20% disodium octoborate tetrahydrate, 10% sodium polyborate and 10% boric acid.

### Example 7

### Water-Dispersible Granule (WG)

Water dispersible granules were prepared comprising epoxiconazole and a micronutrient component, the composition of which is set out in the following table:

| | | |
|---|---|---|
| Epoxiconazole | 1 | g |
| Micronutrient | 20 | g |
| Poly vinyl alcohol | 2 | g |
| Dispersogen 1494 (sodium salt of a | 5 | g |
| cresol-formaldehyde condensation) | | |
| Kaolin | balance to 100 | g |

The micronutrient was composed of 40% calcium chloride, 10% copper carbonate, 10% potassium nitrate, 20% ferrous sulfate and 20% sodium glycolic acid.

### Example 8

### Flowable-Seed Treatment (FS)

A flowable seed treatment composition was prepared having the composition set out in the following table:

| | | |
|---|---|---|
| Tebuconaozle | 2 | g |
| Micronutrient | 40 | g |
| Dispersogen 4387 (anionic polymeric ester) | 5 | g |
| Propylene glycol | 5 | g |
| Xanthan Gum | 2 | g |
| Poly vinyl pyrrolidone | 4 | g |
| Carmosine | 12 | g |
| Water | balance to 100 | g |

The micronutrient was composed of 40% copper chloride, 10% potassium carbonate, 10% sodium nitrate, 20% sodium polyborate and 20% sodium glycolic acid.

### Example 9

### Water-Soluble Concentrates (SL)

A water soluble concentrate comprising tebuconazole as an active ingredient was prepared. The composition is summarized in the following table:

| | | |
|---|---|---|
| Tebuconazole | 25 | g |
| Micronutrient | 0.5 | g |
| TWEEN 80 (Sorbitan monooleate ethoxylate) | 10 | g |
| N-methyl pyrrolidone | Balance to 100 | g |

The micronutrient was composed of 40% sodium citric acid, 10% potassium carbonate, 10% sodium hydrogenphosphite, 20% sodium polyborate and 20% sodium glycolic acid.

### Example 10

### Water-Soluble Concentrates (SL)

A water soluble concentrate comprising tebuconazole as an active ingredient was prepared. The composition is summarized in the following table:

| | | |
|---|---|---|
| Tebuconazole | 10 | g |
| Micronutrient | 1 | g |
| TWEEN 80 (Sorbitan monooleate ethoxylate) | 10 | g |
| N-methyl pyrrolidone | balance to 100 | g |

The micronutrient was composed of 40% calcium hydrogencarbonate, 10% potassium phosphate, 10% sodium hydrogenphosphite, 20% sodium polyborate and 20% sodium glycolic acid.

Test 1

Test for Phytotoxicity on Soybean Plants

Several varieties of soybeans at the growth stage of 5 trifoliates were treated with a commercially available formulation of tebuconazole (Folicur® from Bayer) and formulations of each of Examples 1 to 10 set out above. The rate of application of the triazole active ingredient and the micronutrient (present in the formulations of Examples 1 to 10) are set out in the following tables A to C. After 4 weeks from the treatment date the plant injury was accessed based on area of leaves showing tissue necrosis.

TABLE A
Treatment of Soybean Variety GH3946

| | Rate | |
|---|---|---|
| | (triazole g/ha + micronutrient g/ha) | % Injury |
| Untreated | 0 | 0 |
| Folicur ® | 100 | 25 |
| Example 1 | 100 + 20 | 10 |
| Example 2 | 100 + 5 | 15 |
| Example 3 | 100 + 1 | 20 |
| Example 4 | 100 + 5 | 20 |
| Example 5 | 100 + 100 | 8 |
| Example 6 | 100 + 10000 | 0 |
| Example 7 | 100 + 2000 | 0 |
| Example 8 | 100 + 2000 | 0 |
| Example 9 | 100 + 2 | 20 |
| Example 10 | 100 + 10 | 10 |

TABLE B
Treatment of Soybean Variety USG 7443

| | Rate | |
|---|---|---|
| | (triazole g/ha + micronutrient g/ha) | % Injury |
| Untreated | 0 | 0 |
| Folicur ® | 100 | 15 |
| Example 1 | 100 + 20 | 8 |
| Example 2 | 100 + 5 | 12 |
| Example 3 | 100 + 1 | 10 |
| Example 4 | 100 + 5 | 12 |
| Example 5 | 100 + 100 | 6 |
| Example 6 | 100 + 10000 | 0 |
| Example 7 | 100 + 2000 | 0 |
| Example 8 | 100 + 2000 | 0 |
| Example 9 | 100 + 2 | 12 |
| Example 10 | 100 + 10 | 8 |

TABLE C
Treatment of Soybean Variety DKB 36-52

| | Rate | |
|---|---|---|
| | (triazole g/ha + micronutrient g/ha) | % Injury |
| Untreated | 0 | 0 |
| Folicur ® | 100 | 20 |
| Example 1 | 100 + 20 | 8 |
| Example 2 | 100 + 5 | 12 |
| Example 3 | 100 + 1 | 16 |
| Example 4 | 100 + 5 | 16 |
| Example 5 | 100 + 100 | 6 |
| Example 6 | 100 + 10000 | 0 |
| Example 7 | 100 + 2000 | 0 |
| Example 8 | 100 + 2000 | 0 |
| Example 9 | 100 + 2 | 16 |
| Example 10 | 100 + 10 | 8 |

As can be seen from the date in Tables A to C, the inclusion of the micronutrient component in the treatment of the soybean plants significantly reduced the phytotoxic effects of the triazole active ingredients. At low to moderate concentrations, the micronutrient reduced the phytotoxicity of the tebuconazole, compared with the comparative test. At higher concentrations, the micronutrient component was effective in eliminating the tissue necrosis.

Test 2

Test for Fungicidal Properties on Soybean Plants

Young soybean plants were sprayed with a conidial suspension of white mold (Sclerotinia sclerotiorum), and incubated at 20° C. and 100% relative atmospheric humidity for 48 hours. Then they were sprayed with tebuconazole (Folicur® from Bayer) and treated with formulations of Examples 1 to 10 set out above. After staying in a greenhouse at 15° C. and 80% relative atmospheric humidity for 12 days, fungicidal efficacy was assessed. The results of the assessment are set out in Table D below, where 100% indicates no fungicidal infection was observed and 0% corresponds to efficacy of the control.

TABLE D

| | Rate | Efficacy |
|---|---|---|
| | (triazole g/ha + micronutrient g/ha) | in % |
| Untreated | 0 | 0 |
| Folicur ® | 100 | 80 |
| Example 1 | 100 + 20 | 94 |
| Example 2 | 100 + 5 | 87 |
| Example 3 | 100 + 1 | 82 |
| Example 4 | 100 + 5 | 87 |
| Example 5 | 100 + 100 | 98 |
| Example 6 | 100 + 10000 | 100 |
| Example 7 | 100 + 2000 | 100 |
| Example 8 | 100 + 2000 | 100 |
| Example 9 | 100 + 2 | 84 |
| Example 10 | 100 + 10 | 90 |

As can be seen from the date set out in Table D, the presence of the micronutrient component significantly enhanced the fungicidal activity of the triazole active ingredients, compared with the treatment without micronutrient addition. In particular, it will be noted that the combination of a triazole and a micronutrient at certain concentrations was effective in completely combating the fungicidal infestation.

1. A fungicidal composition comprising a triazole fungicide and a micronutrient.

2. The composition according to claim 1, wherein the triazole fungicide is selected from azaconazole, bitertanol, bromuconazole, cyproconazole, diclobutrazole, difenoconazole, diniconazole, enilconazole, epoxiconazole, etaconazole, fenbuconazole, fluquinconazole, flusilazole, flutriafol, hexaconazole, imibenconazole, ipconazole, metconazole, myclobutanil, paclobutrazol, penconazole, propiconazole, prothioconazole, simeconazole, tebuconazole, tetraconazole, triadimefon, triadimenol, triticonazole, and mixtures thereof.

3. The composition according to claim 2, wherein the triazole fungicide is selected from tebuconazole, epoxiconazole, difenoconazole, cyproconazole and hexaconazole.

4. The composition according to claim 3, wherein the triazole fungicide is tebuconazole.

5. The composition according to claim 1, wherein the micronutrient comprises a salt comprising a cation of a Group I metal, a Group II metal, a transition metal, or an ammonium cation.

6. The composition according to claim 5, wherein the micronutrient comprises a salt comprising a cation of Na, K, Fe, Mn, Zn, Cu, or Mo.

7. The composition according to claim 1, wherein the micronutrient comprises a salt comprising an anion of an inorganic acid.

8. The composition according to claim 7, wherein the inorganic acid is a hydrohalic acid, carbonic acid, sulphuric acid, phosphoric acid or nitric acid.

9. The composition according to claim 1, wherein the micronutrient comprises a salt comprising an anion of an organic acid.

10. The composition according to claim 1, wherein the micronutrient comprises a salt selected from sulphates, molybdates, phosphates, hydrogenphosphites, nitrates, halides, borates, carbonates and vitriols.

11. The composition according to claim 1, wherein the micronutrient comprises a salt selected from metal salt of H2BO3- and HBO32-, boric acid and salts of tetraborate and polyborate.

12. The composition according to claim 1, wherein the triazole is present in an amount of from 2 to 50% by weight of the composition.

13. The composition according to claim 1, wherein the micronutrient is present in an amount of from 2 to 20% by weight of the composition.

14. A method of reducing phytotoxicity caused by a triazole fungicide on a target plant according to claim 1, the method comprising providing the triazole fungicide to the target plant in the presence of a micronutrient.

15. The method of claim 14, wherein the triazole and the micronutrient are provided to the target plant in the same composition.

16. The method according to claim 14, wherein the target plant is soybean.

17. The method according to claim 14, wherein the triazole fungicide is selected from azaconazole, bitertanol, bromuconazole, cyproconazole, diclobutrazole, difenoconazole, diniconazole, enilconazole, epoxiconazole, etaconazole, fenbuconazole, fluquinconazole, flusilazole, flutriafol, hexaconazole, imibenconazole, ipconazole, metconazole, myclobutanil, paclobutrazol, penconazole, propiconazole, prothioconazole, simeconazole, tebuconazole, tetraconazole, triadimefon, triadimenol, triticonazole, and mixtures thereof.

18. The method according to according to claim 17, wherein the triazole fungicide is selected from tebuconazole, epoxiconazole, difenoconazole, cyproconazole and hexaconazole.

19. The method according to according to claim 18, wherein the triazole fungicide is tebuconazole.

20. The method according to according to claim 14, wherein the micronutrient comprises a salt comprising a cation of a Group I metal, a Group II metal, a transition metal, or an ammonium cation.

21. The method according to according to claim 20, wherein the micronutrient comprises a salt comprising a cation of Na, K, Fe, Mn, Zn, Cu, or Mo.

22. The method according to according to claim 14, wherein the micronutrient comprises a salt comprising an anion of an inorganic acid.

23. The method according to according to claim 22, wherein the inorganic acid is a hydrohalic acid, carbonic acid, sulphuric acid, phosphoric acid or nitric acid.

24. The method according to claim 14, wherein the micronutrient comprises a salt comprising an anion of an organic acid.

25. The method according to according to claim 14, wherein the micronutrient comprises a salt selected from sulphates, molybdates, phosphates, hydrogenphosphites, nitrates, halides, borates, carbonates and vitriols.

26. The method according to according to claim 14, wherein the micronutrient comprises a salt selected from metal salt of H2BO3- and HBO32-, boric acid and salts of tetraborate and polyborate.

27. The method according to claim 14, wherein the triazole fungicide and the micronutrient are provided to the target plant in a weight ratio of from 1:20 to 20:1.

28. A method of protecting a plant against a fungus, comprising applying a triazole fungicide and one or more micronutrients to the plant, a part thereof, or to the surroundings thereof according to claim 1.

29. The method according to claim 28, comprising applying to the plant, a part thereof or the surroundings thereof a composition according to any of claims 1 to 13.

30. A method of improving the fungicidal activity of a triazole fungicide at a locus, the method comprising applying the fungicide and a micronutrient to the locus according to claim 1.

31-35. (canceled)
